(19) United States
(12) Patent Application Publication
(10) Pub. No.: US 2002/0085088 A1
(43) Pub. Date: Jul. 4, 2002

(54) Information processor and method for processing information

(76) Inventor: Curtis Eubanks, Tokyo (JP)

Correspondence Address: LAW OFFICES, LERNER, DAVID, LITTENBERG, KRUMHOLZ & MENTLIK, LLP, 600 SOUTH AVENUE WEST, WESTFIELD, NJ, 07090-1497, US

(21) Appl. No.: 09/864,658

(22) Filed: May 24, 2001

(30) Foreign Application Priority Data
May 25, 2000 (JP) P2000-155260

(51) Int. Cl. H04N 7/00; H04N 11/00

(52) U.S. Cl. 348/22; 348/24

(57) ABSTRACT

According to the present invention, it is possible to extract a specified video frame as a still image from a video stream recorded in a record medium of another information processor. A sender information processor sends to a receiver information processor connected to a network a command to extract and generate a specified video frame of a video stream recorded in a record medium, and then to send the video frame to the sender after converting the video frame into still image data. The receiver extracts and generates a requested video frame based on the command, and obtains still image data from the video frame. Then, the receiver sends the still image data to the sender. In this case, the receiver extracts and generates a video frame which corresponds to the video frame specification information included in the command, so as to obtain still image data which corresponds to the image format and size information included in the command. The sender receives the still image data from the receiver.

### CROSS-REFERENCE TO RELATED APPLICATIONS

The present application claims priority from Japanese Application No. P2000-155260 filed May 25, 2000, the disclosure of which is hereby incorporated by reference herein.

### BACKGROUND OF THE INVENTION

The present invention relates to an information processor preferably for use in an audio visual system (AV system), and a method for processing information. Specifically, the present invention relates to an information processor and the like structured in a manner that it sends to another information processor connected to a network a command for requesting the extraction and generation of a specified video frame of a video stream recorded in a record medium, and for requesting that the video frame be sent after it is converted into still image data, and in which the information processor receives still image data of the specified video frame sent from another information processor, whereby the specified video frame can be extracted as a still image from the video stream recorded in the record medium of another information processor.

The IEEE 1394 council defines several audio visual control (AV/C) command sets including the general specification of an AV/C disc subunit (see AV/C Disc subunit, General Specification 1.0 version 1.0, Jan. 26, 1999). In this definition, support for the positioning performed by an AV frame has been added to the specification of the AV/C disc subunit extension in the hard disc drive specification (see AV/C Disc Subunit Enhancements for Hard Disc Drive Specification, version 0.7, Apr. 12, 1999).

The IEEE 1394 council further defines, in another document, an AV/C command for a disc medium of a specific type such as mini disc (MD) or AV hard disc drive. The disc medium, such as a digital versatile disc (DVD) and a hard disc drive, may possibly include both a video image and a still image. The video image and the still image are accessible by use of their respective AV/C commands by the application in the network.

There is a possibility that a certain application in the 1394 home network desires access to one or plural specific frames in a video track recorded in a network apparatus such as an AV-HDD. This is useful in a video browsing application in which a still frame is displayed for each of the video tracks on a hard disc drive. Or alternatively, a certain application displays one still frame obtained from each scene in one AV track, thereby providing the ability to browse the AV track to the user.

There is no method for efficiently extracting a specific frame from a video stream by employing the conventional IEEE-1394 AV/C specification for a disc subunit. A video object is always handled as a streaming video, and an image object is handled as an image separately from the video object. Conversion between the video object and the image object is not supported by the AV/C command.

It is possible to search a specific point on a disc or a specific point in a track by employing the conventional AV/C disc subunit specification. The application thereof can send a play control command by a forward pause in a play mode.

However, this operation merely repeats the play of the same frame, and wastes band width. The application which has requested this operation still has to store a video stream and produce a stop command, and then to decode the stored video so as to convert the video into a still image format such as JPEG (see section 10.7 of the “AV/C Disc Subunit, General Specification 1.0” described above).

### SUMMARY OF THE INVENTION

The present invention provides an information processor and the like capable of extracting a specific video frame as still image data from a video stream.

In an aspect of the present invention, a first information processor connected to a network with another information processor having a record medium recorded with a video stream includes a command generator operable to generate a command requesting the another information processor to extract and produce a specified video frame of the video stream recorded in the record medium, and to send the video frame after converting it into still image data; a command sender operable to send the command to the another information processor; and an image data receiver operable to receive the still image data from the another information processor.

In another aspect of the present invention, a method is provided for processing information in a first information processor connected to a network with another information processor having a record medium recorded with a video stream. The method includes generating in the first information processor a command requesting the another information processor to extract and produce a specified video frame of the video stream recorded in the record medium, and to send the video frame after converting it into still image data; sending the generated command to the another information processor; and receiving in the first information processor the still image data sent from the another information processor.

In still another aspect of the present invention, a first information processor connected to a network with another information processor includes a record medium in which a video stream is recorded; a command receiver operable to receive a command from the another information processor requesting that a specified video frame of the video stream recorded in the record medium be extracted and generated and that the specified video frame be sent after converting it into still image data; a video frame extractor and generator operable to extract and generate the specified video frame from the record medium based on the command received by the command receiver; an image data converter operable to obtain still image data from the specified video frame extracted and generated by the video frame extractor and generator; and an image data sender operable to send the still image data to the another information processor.

In still another aspect of the present invention, a method is provided for processing information in a first information processor connected to a network with another information processor, the first information processor having a record medium recorded with a video stream. The method includes receiving in the first information processor a command from the another information processor requesting that a specified video frame of the video stream be extracted and generated, and that the specified video frame be sent after converting it into still image data; extracting and generating the specified video frame from the record medium based on the received command; obtaining still image data from the specified video frame which has been extracted and generated; and sending the obtained still image data to the another information processor.

In the present invention, a first information processor and a second information processor are connected to one and the same network, for example, an IEEE 1394 network. The second information processor includes a record medium, for example, a hard disc or the like, in which a video stream is recorded. The first information processor generates a command requesting the second information processor to extract and generate a specified video frame of the video stream recorded in the record medium, and to send the video frame after converting the video frame into still image data. After that, the first information processor sends this command to the second information processor.

The command includes, for example, video frame specification information operable to specify the video frame to be extracted and generated from the record medium; image format specification information operable to specify an image format of the still image data; image size specification information operable to specify the size of the still image; output plug specification information operable to specify an output plug for outputting the still image data, and the like.

The second information processor receives the command sent from the first information processor, and based on the command, extracts and generates the specified video frame from the record medium. When the command includes information operable to specify the video frame to be extracted and generated, the second information processor extracts and generates the video frame specified by this information.

Then, the second information processor obtains the still image data from the specified video frame which it has extracted and generated, and sends the still image data to the first information processor. When the command includes information operable to specify the image format and size of the still image data, the second information processor obtains the still image data of the image format and size specified by this information. When the command includes information operable to specify the output plug, the second information processor outputs the still image data to the output plug.

The first information processor receives the still image data sent from the second information processor. In this manner, the first information processor can extract a specified video frame as a still image from the video stream recorded in the record medium of the second information processor.

### BRIEF DESCRIPTION OF THE DRAWINGS

FIG. 1 is a block diagram showing the IEEE 1394 network system.

FIG. 2 is a block diagram showing a structure of the sender.

FIG. 3 is a block diagram showing a structure of the disc subunit (receiver).

FIG. 4 is an explanatory diagram showing an exemplary cycle structure of data transmission through the IEEE 1394 bus.

FIG. 5 is an explanatory diagram showing an exemplary structure of the address space of the CRS architecture.

FIG. 6 is an explanatory diagram showing the position, name, and operation of the main CRS.

FIG. 7 is an explanatory diagram showing an exemplary general ROM format.

FIG. 8 is an explanatory diagram showing an exemplary bus info block, route directory, and unit directory.

FIG. 9 is an explanatory diagram showing an exemplary structure of a PCR.

FIGS. 10A to 10D are explanatory diagrams showing exemplary structures of an oMPR, an oPCR, an iMPR, and an iPCR.

FIG. 11 is an explanatory diagram showing an exemplary relationship between the plug, plug control register, and transmission channel.

FIG. 12 is an explanatory diagram showing an exemplary data structure in accordance with the hierarchical structure of the descriptor.

FIG. 13 is an explanatory diagram showing an exemplary data format of the descriptor.

FIG. 14 is an explanatory diagram showing an exemplary generation ID of FIG. 13.

FIG. 15 is an explanatory diagram showing an exemplary list ID of FIG. 13.

FIG. 16 is an explanatory diagram showing an exemplary stack model of the AV/C command.

FIG. 17 is an explanatory diagram showing the relationship between the command and response of FCP.

FIG. 18 is an explanatory diagram showing the relationship between the command and response of FIG. 17 in more detail.

FIG. 19 is an explanatory diagram showing an exemplary data structure of the AV/C command.

FIGS. 20A to 20C are explanatory diagrams showing a specific example of the AV/C command.

FIGS. 21A and 21B are explanatory diagrams showing a specific example of the command and response of the AV/C command.

FIG. 22 is a flow chart showing an operation of the sender for sending an extract command.

FIG. 23 is a flow chart showing an operation of the receiver for receiving an extract command.

FIG. 24 is a diagram showing an example of the directory structure of the disc.

### DETAILED DESCRIPTION

Hereinafter, embodiments of the present invention will be described with reference to the drawings.

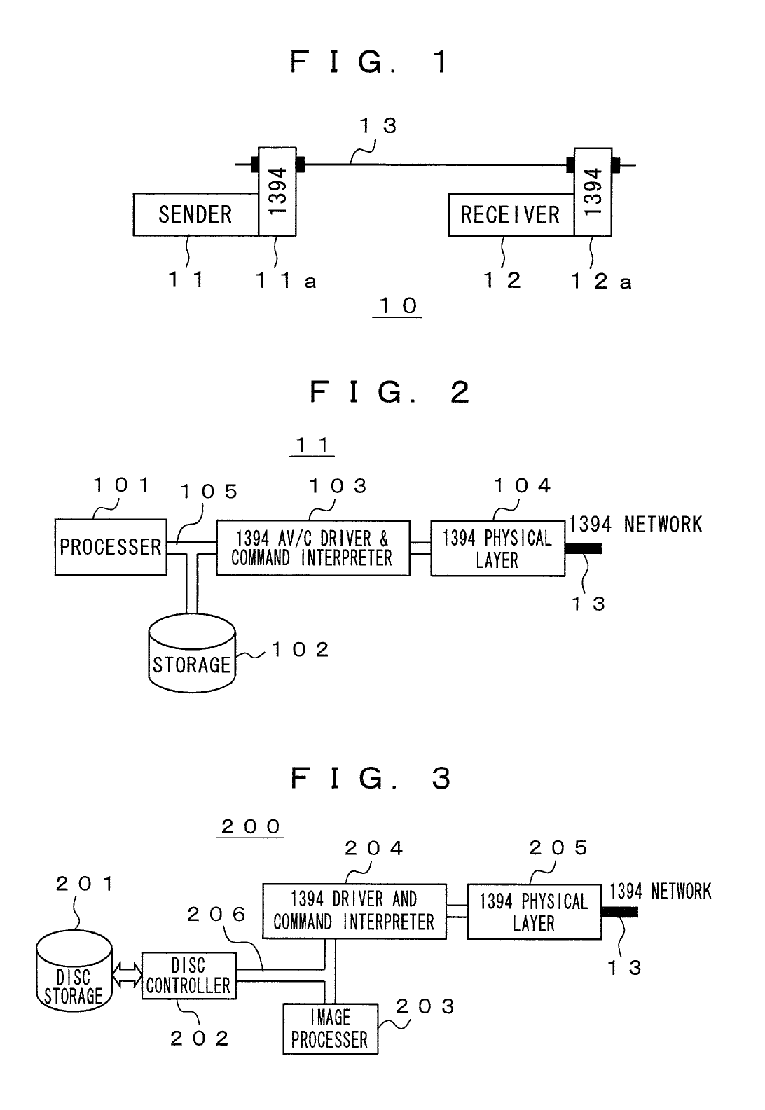

FIG. 1 is a diagram showing an IEEE 1394 network system 10. The IEEE 1394 network system 10 has a structure in which a sending device 11 (hereinafter, referred to as a “sender”) which conforms to the IEEE 1394 standard, and a disc subunit receiving device 12 (hereinafter, referred to as a “receiver”) which conforms to the IEEE 1394 standard are connected to each other via an IEEE 1394 network 13. The sender 11 and the receiver 12 respectively have 1394 hardware 11a and 12a.

FIG. 2 is a diagram showing a structure of the sender 11. The sender 11 serves to request still image data from the receiver 12. The sender 11 includes a processor 101, a storing device (a storage) 102, a 1394 AV/C driver and command interpreter 103, and 1394 physical layer hardware 104. The storage 102 and the 1394 AV/C driver and command interpreter 103 are connected to the processor 101 via a bus 105. The 1394 physical layer hardware 104 is connected to the 1394 network 13. The 1394 physical layer hardware 104 is controlled by the 1394 AV/C driver and command interpreter 103.

FIG. 3 is a diagram showing a structure of a disc subunit 200 as the receiver 12. The disc subunit 200 includes a disc storing unit (disc storage) 201, a disc controller 202 for controlling the disc storage 201, an image processor 203, a 1394 driver and command interpreter 204, and 1394 physical layer hardware 205.

Each of the disc controller 202, the image processor 203, and the 1394 driver and command interpreter 204 is connected to an internal system bus 206. The 1394 physical layer hardware 205 is connected to the 1394 network 13. The 1394 driver and command interpreter 204 functions as an interface between an internal system bus 206 and the 1394 physical layer hardware 205.

The image processor 203 is a processing unit having a volatile memory (not shown). The image processor 203 has an ability of decoding digital video track data (for example, MPEG data) stored in the disc storage 201, and an ability of encoding still image data in at least one format. The data from the 1394 driver and command interpreter 204 is sent to the 1394 network 13 via the 1394 physical layer hardware 205.

FIG. 3 shows an exemplary structure of the hardware which can be employed in the present invention, and it should be understood that there are many other equivalent structures which can be employed in the present invention. For example, either two or all of the disc controller 202, the image processor 203, and the 1394 driver and command interpreter 204 may be combined to each other. In this case, the internal system bus 206 can be omitted. In addition, FIG. 3 shows a theoretical functional block, and for example, the function of the 1394 driver and command interpreter 204 and the function of the 1394 physical layer hardware 205 may be realized on one and the same physical chip.

Hereinafter, the IEEE 1394 network 13 constituting the IEEE 1394 network system 10 will be described.

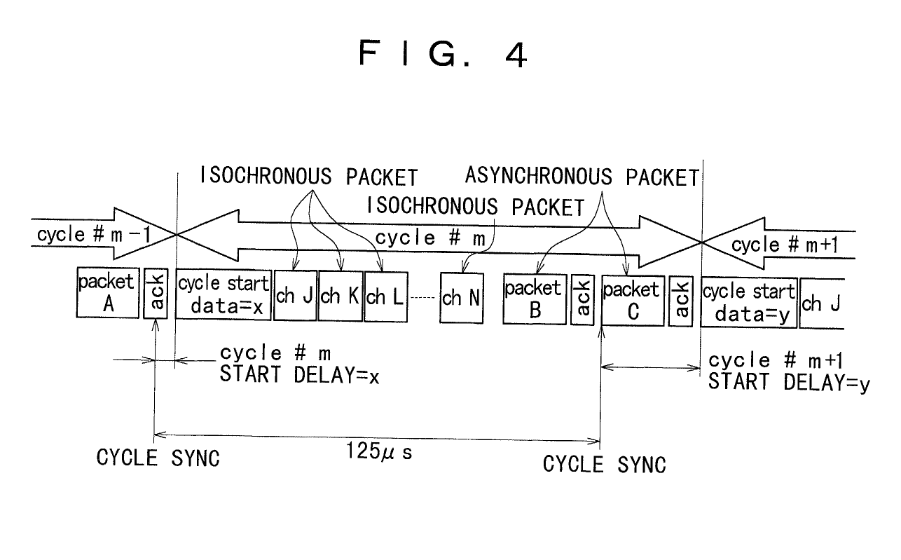

FIG. 4 is a diagram showing a data transmission cycle structure of a device interconnected by the IEEE 1394. According to the IEEE 1394, data may be divided into packets, and transmitted in a time-division manner based on a cycle of duration of 125 (s). The cycle described above is created by a cycle start packet supplied from a node having a cycle master function (i.e., any equipment connected to the bus) In isochronous transmission, the band required for data transmission (although this is a unit of time, it is referred to as a band) is secured from the first portion of the cycle. Therefore, in isochronous transmission, data transmission within a fixed time is assured. However, since isochronous transmission has no arrangement for data protection, the data is lost when transmission errors occur. On the other hand, in asynchronous transmission, the node sends the asynchronous packet when it has obtained the right to use the bus as a result of arbitration during the time when the bus is not used for isochronous transmission in each cycle. Reliable transmission is possible by using acknowledgement and retry; however, the transmission is not executed within a fixed time.

In order to allow a predetermined node to execute isochronous transmission, it is required that the node have an isochronous function. In addition, at least one of nodes having an isochronous function must also have a cycle master function. Furthermore, at least one of the nodes connected to the IEEE 1394 network 13 must have an isochronous resource managing function.

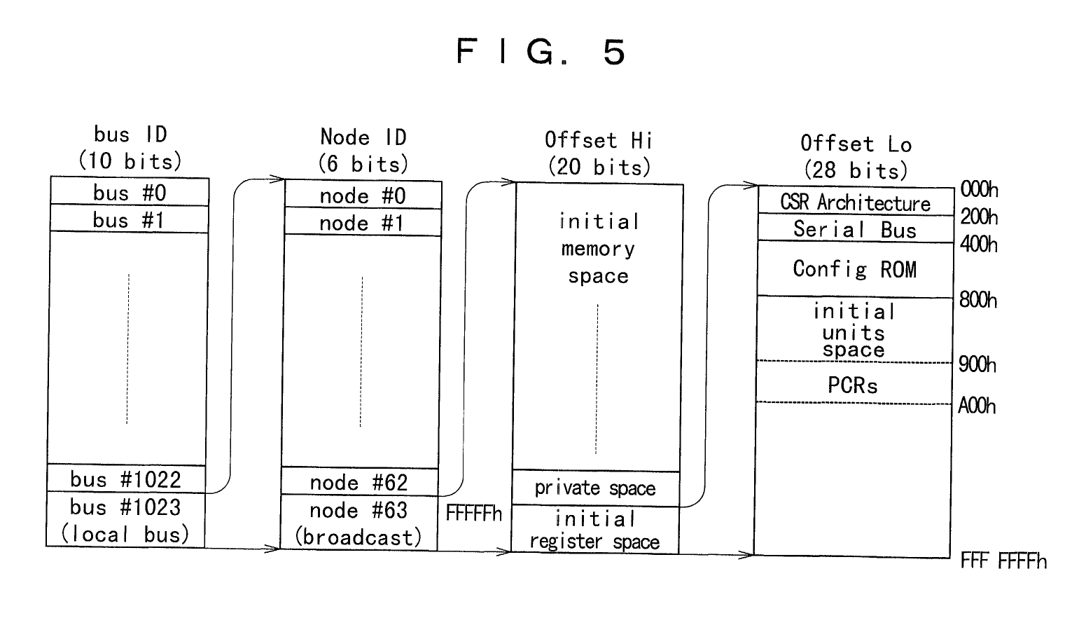

The IEEE 1394 is based on the CSR (Control & Status Register) architecture having a 64-bit address space as prescribed by the ISO/IEC 13213 standard. FIG. 5 is a diagram to which reference will be made in explaining the structure of the address space of the CSR architecture. The first 16 bits may be node IDs indicative of the nodes on each IEEE 1394, and the remaining 48 bits may be used to designate the address space assigned to each node. The first 16 bits may further be divided into 10 bits of a bus ID and 6 bits of a physical ID (node ID in a narrow sense). Since the values in which all bits are set to 1 may be used for a special purpose, there can be designated 1023 buses and 63 nodes.

In the address space with 256 terabytes defined by the remaining 48 bits, the space defined by the first 20 bits is divided into an initial register space which is used for a register specific to a 2048 byte CSR and a register specific to the IEEE 1394 standard, a private space, and an initial memory space. The space defined by the remaining 28 bits is used, when the space defined by the first 20 bits is an initial register space, as a configuration read only memory (ROM), an initial unit space for a use specific to the node, a plug control register (PCRs), or the like.

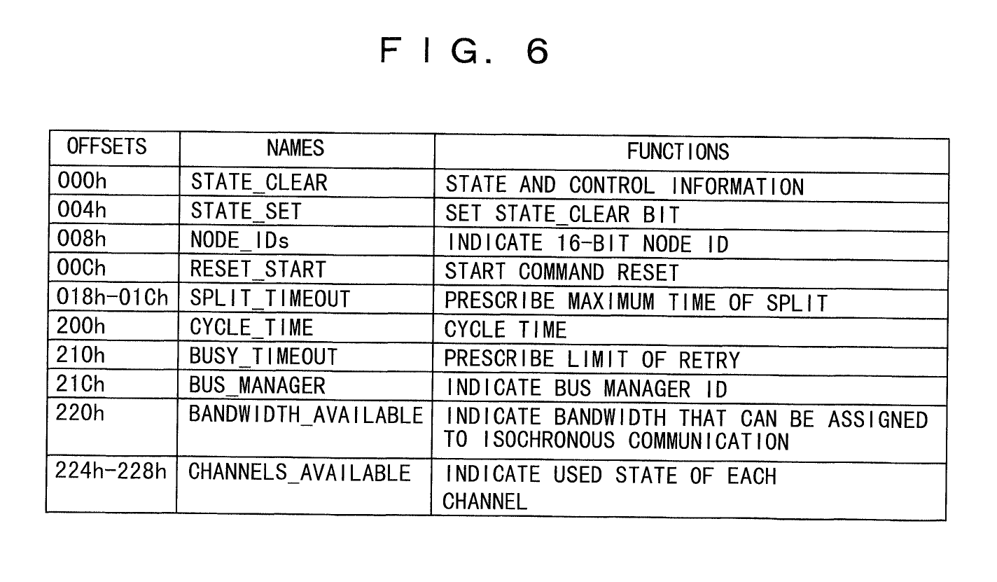

FIG. 6 is a diagram for illustrating an offset address, name, and operation of the main CSR. The term “offset” in FIG. 6 shows the offset address relative to the FFFFF0000000h address (the h at the rearmost end indicates that the address is in a hexadecimal notation) from which the initial register space begins. The bandwidth available register having an offset of 220h indicates a bandwidth which can be allocated to isochronous transmission, and recognizes only the value of the node operating as an isochronous resource manager to be effective. Specifically, while each node has the CSR structure shown in FIG. 5, the bandwidth available register in only the isochronous resource manager is recognized to be effective. In other words, it is only the isochronous resource manager that actually has the bandwidth available register. In the bandwidth available register, a maximum value is stored when no bandwidth has been allocated to isochronous transmission, and the value thereof is reduced every time a bandwidth is allocated to isochronous transmission.

The channels available registers from offset 224h to 228h correspond to channel numbers with 0 to 63 bits, respectively. A channel number with 0 bits means that the channel has already been allocated to the channels available register. The channels available register is effective only in the node operating as an isochronous resource manager.

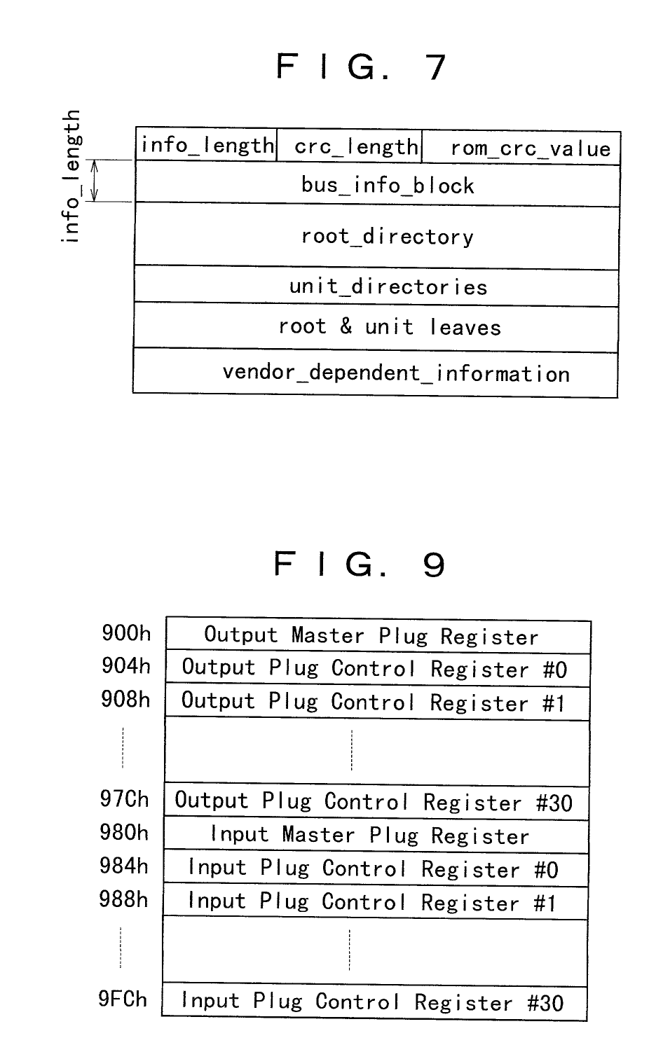

Referring again to FIG. 5, a configuration read only memory (ROM) based on a general read only memory (ROM) format is arranged in the addresses 200h to 400h within the initial unit space. FIG. 7 is a diagram for illustrating the general ROM format. The node, which is a unit of access on the IEEE 1394 standard, can hold a plurality of units capable of operating independently while having a common address space in the node. The unit directories can indicate the version and the position of the software for the unit. The bus info block and the root directory are located at fixed positions, and the other blocks are located at positions designated by the offset address.

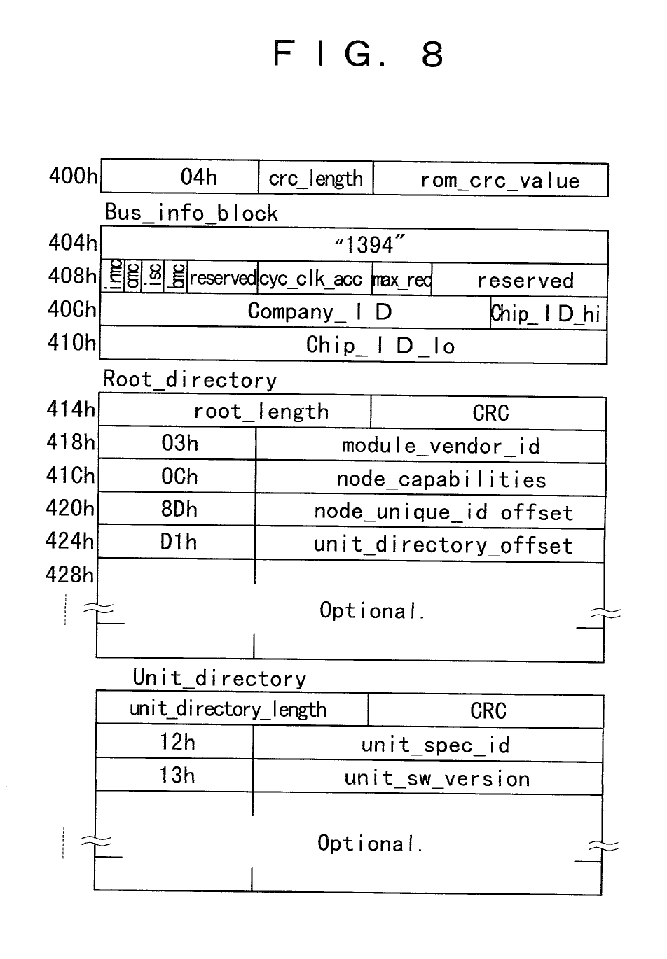

FIG. 8 is a diagram showing the bus info block, root directory, and unit directory in detail. An ID number indicating the manufacturer of the equipment is stored in the company ID field in the bus info block. An ID which is unique to the equipment and which is the only one ID in the world which does not overlap other IDs is stored in the chip ID field. 00h is written into the first octet of the unit spec ID field of the unit directory of equipment satisfying the requirements of the IEC 61883 standard, Aoh is written into the second octet thereof, and 2Dh is written into the third octet thereof. Furthermore, 01h is written in the first octet of the unit switch version field, and 1 is written into the least significant bit (LSB) of the third octet.

The node has a plug control register (PCR) defined by the IEC 61883 standard in the addresses 900h to 9FFh within the initial unit space shown in FIG. 5, in order to control input/output with respect to the equipment via an interface. This design embodies the concept of plug to form a signal path logically similar to an analog interface. FIG. 9 is a diagram for illustrating the structure of a PCR. The PCR has an output plug control register (oPCR) indicating an output plug, and an input plug control register (iPCR) indicating an input plug. The PCR also has an output master plug register (oMPR) or an input master plug register (iMPR) for indicating information on an output plug or an input plug specific to each device. While each device does not have a plurality of oMPRS or iMPRS, it is possible to have a plurality of oPCRS or iPCRS corresponding to individual plugs depending on the ability of the device. Each of the PCRs shown in FIG. 9 has 31 oPCRs and 31 iPCRs. The isochronous data flow is controlled by manipulating the registers corresponding to these plugs.

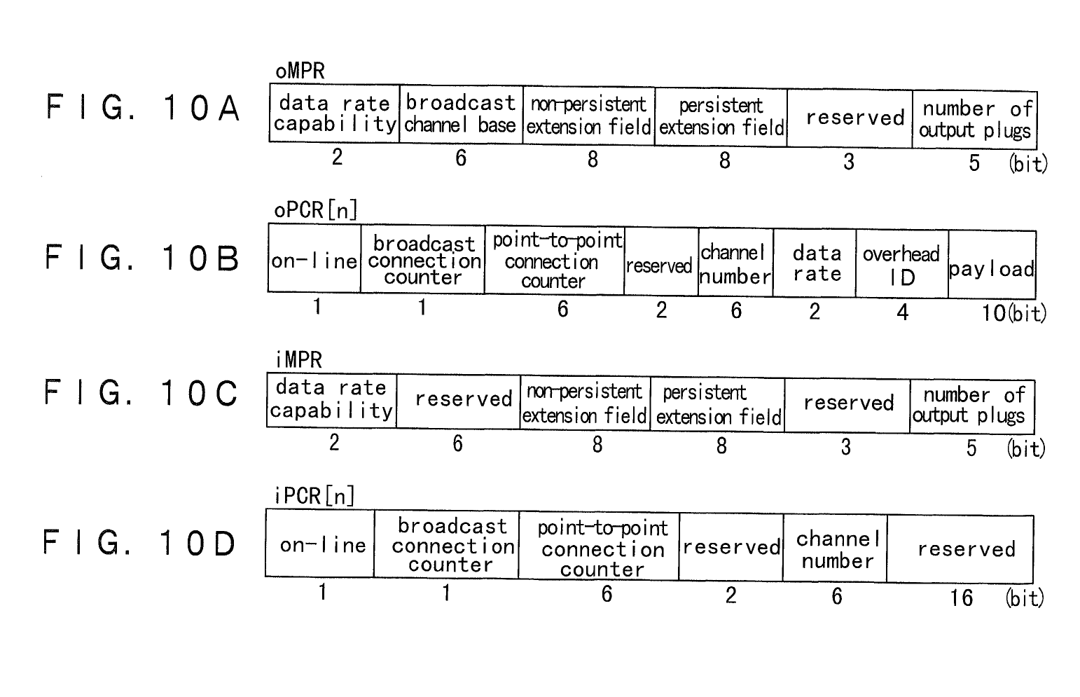

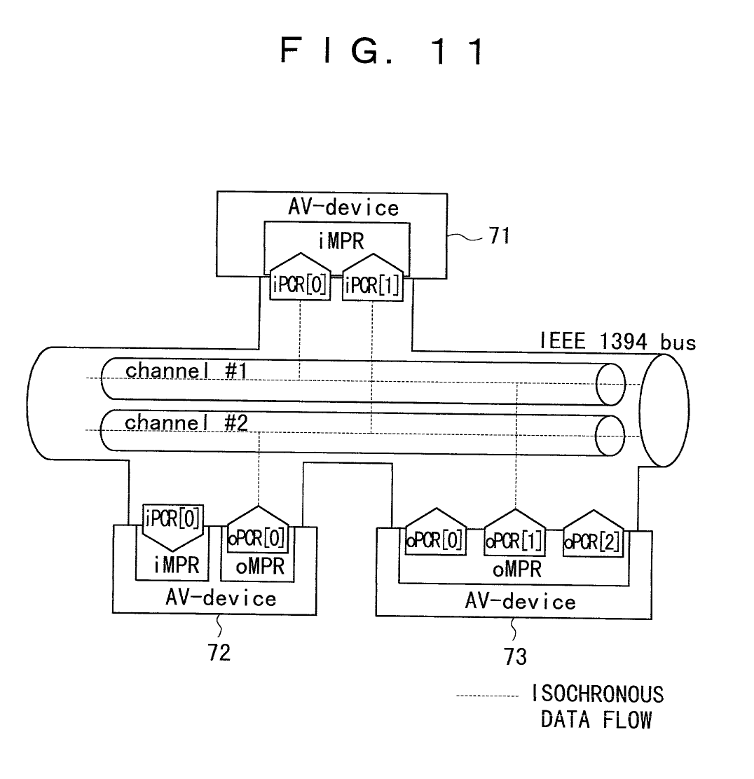

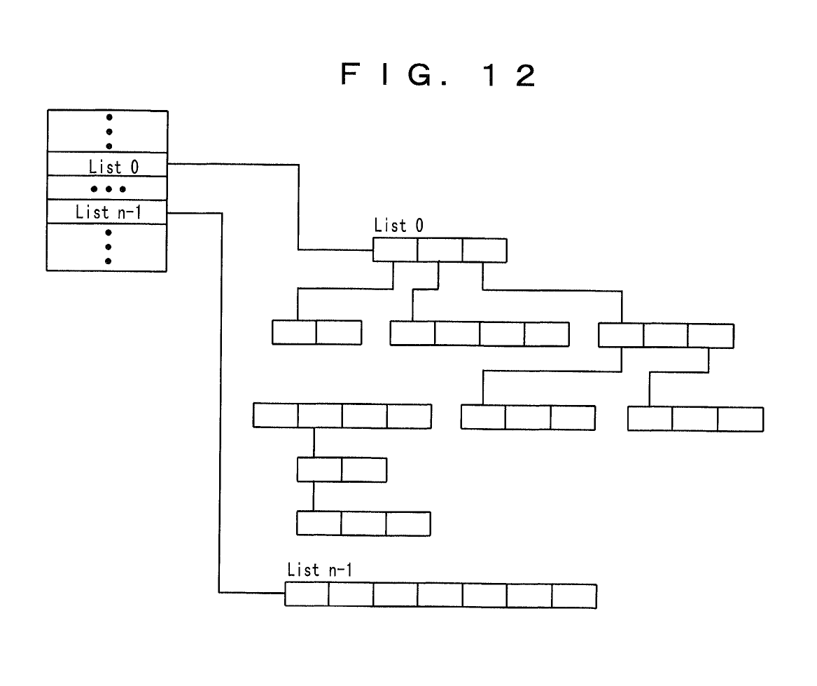

FIGS. 10A to 10D are diagrams showing the structures of an oMPR, oPCR, iMPR, and iPCR, respectively. FIG. 10A shows the structure of an oMPR, FIG. 10B shows the structure of an oPCR, FIG. 10C shows the structure of an iMPR, and FIG. 10D shows the structure of an iPCR. A code indicating the maximum transmission rate of isochronous data which the device can send or receive is stored in the 2 bit data rate capability field on the MSB side of each oMPR and iMPR. A broadcast channel base field in the oMPR defines the channel number to be used for broadcast output.

The number of output plugs that the device has, that is, the value showing the number of oPCRs, is stored in the 5 bit number of output plugs field on the LSB side of the oMPR. The number of input plugs that the device has, that is, the value showing the number of iPCRS, is stored in the 5 bit number of input plugs field on the LSB side of the iMPR. A non-persistent extension field and a persistent extension field are regions defined for future expansion.

An on-line field on the MSB side of both the oPCR and the iPCR indicates the use state of the plug. Specifically, a value of 1 in the on-line field means that the plug is in an on-line state, and a value of 0 in the on-line field means that the plug is in an off-line state. The values in the broadcast connection counter fields of both the oPCR and iPCR indicate the presence (a value of 1) or absence (a value of 0) of a broadcast connection. The values in the 6 bit point-to-point connection counter fields in both the oPCR and iPCR indicate the number of point-to-point connections that the plug has.

The values in the 6 bit channel number fields in both the oPCR and iPCR indicate the isochronous channel number to which the plug is to be connected. The value in the 2 bit data rate field in the oPCR indicates an actual transmission rate of the packets of isochronous data to be output from the plug. The code stored in the 4 bit overhead ID field in the oPCR shows the bandwidth over the isochronous communication. The value in the 10 bit payload field in the oPCR indicates the maximum value of the data contained in the isochronous packets that can be handled by the plug.

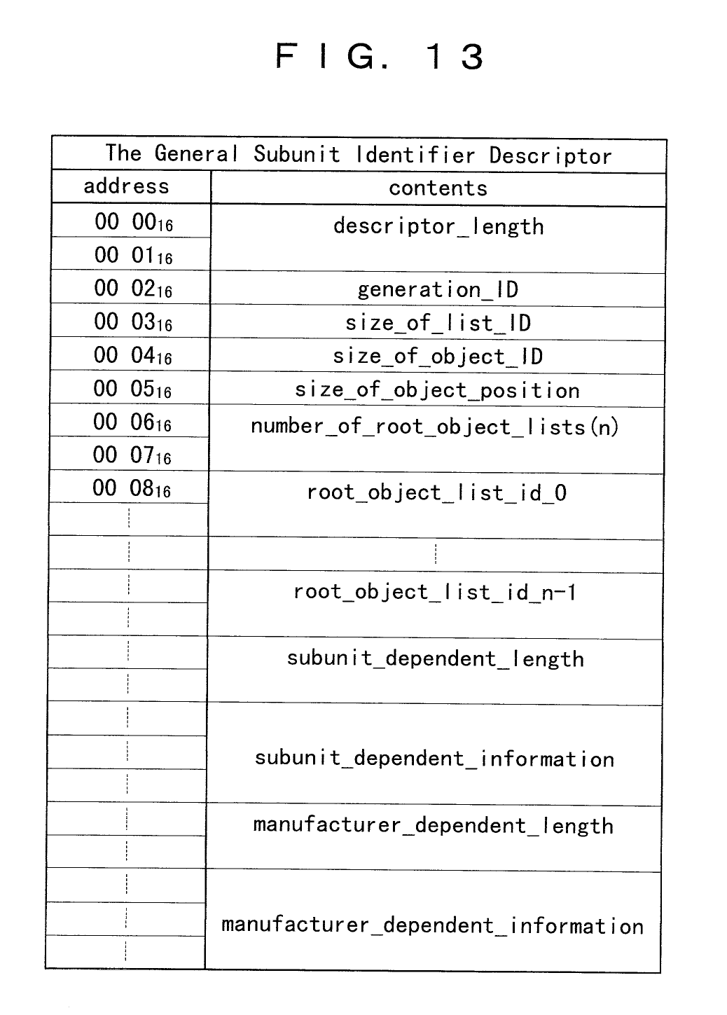

FIG. 11 is a diagram showing the relationship among a plug, a plug control register, and an isochronous channel. AV devices 71 to 73 are connected to each other by an IEEE 1394 serial bus. The oMPR in the AV device 73 defines the number and transmission rate of the oPCR[0] to oPCR[2]. The isochronous data for which the channel is designated by the oPCR [1] is sent to channel #1 in the IEEE 1394 serial bus. The iMPR in the AV device 71 defines the number and transmission rate of the iPCR[0] and iPCR[1]. The AV device 71 reads the isochronous data which has been sent to channel #1 in the IEEE 1394 serial bus as designated by the iPCR[0]. Similarly, the AV device 72 sends isochronous data to channel #2 designated by the oPCR[0]. The AV device 71 reads the isochronous data from channel #2 as designated by the iPCR[1].

In the aforementioned manner, data transmission is executed among the devices connected to each other by the IEEE 1394 serial bus. In this structure, each device can be controlled and the state thereof can be determined by use of an AV/C command set defined as commands for controlling the devices connected to each other by the IEEE 1394 serial bus. Hereinafter, the AV/C command set will be described.

First, a data structure of the subunit identifier descriptor in the AV/C command set will be described with reference to FIGS. 12 to 15. FIG. 12 is a diagram showing a data structure of the subunit identifier descriptor. As seen in FIG. 12, the data structure of the subunit identifier descriptor consists of hierarchical lists. In the case of a tuner, for example, the term “list” means a channel through which data can be received, and, in the case of a disc, for example, the term “list” means music recorded thereon. The uppermost list in the hierarchy is referred to as a root list, and list 0 is a root for the lists at lower positions, for example. Similarly, the lists 2 to (n−1) are also root lists. There are as many root lists as there are objects. The term “object” means, in the case where the AV device is a tuner, each channel in a digital broadcast. All the lists in one hierarchy share the same information.

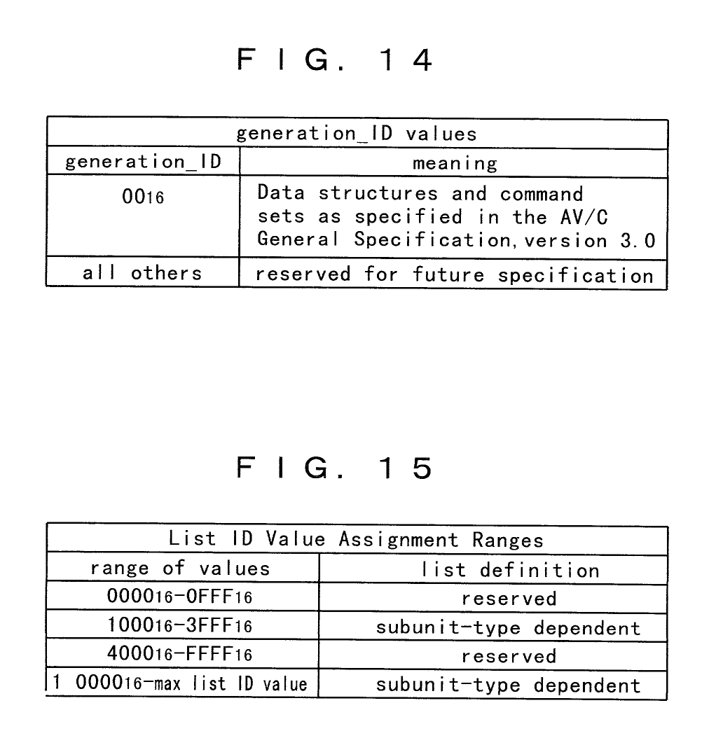

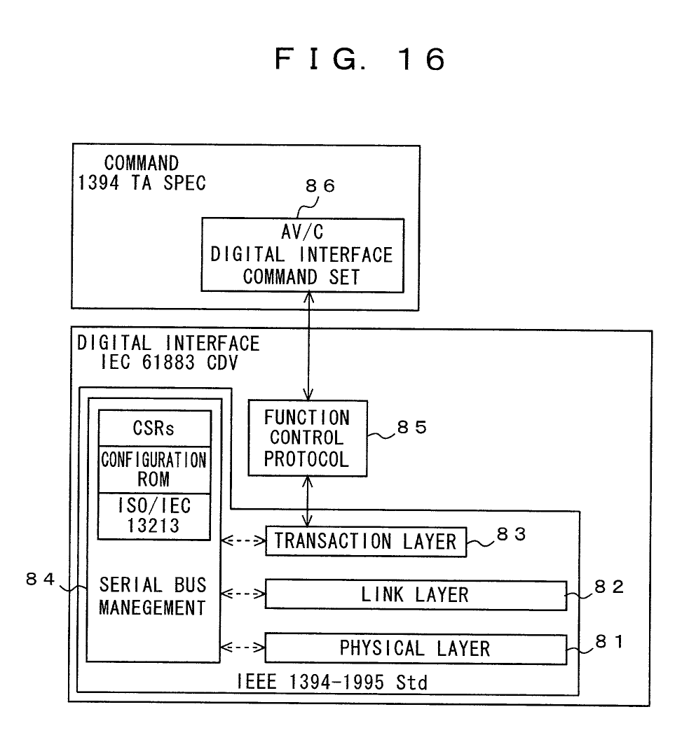

FIG. 13 is a diagram showing a format of the general subunit identifier descriptor. The subunit identifier descriptor has contents including attribute information as to functions. It does not include a value of the descriptor length field itself. The generation ID field indicates the AV/C command set version, and its value is at “00h” (the h designates that this value is in hexadecimal notation) at present, as shown in FIG. 14. The value of “00h” means that the data structure and the command set are of AV/C general specification, version 3.0. In addition, as shown in FIG. 14, all the values except for “00h” are reserved for future specification.

The size of list ID field shows the number of bytes of the list ID. The size of object ID field shows the number of bytes of the object ID. The size of object position field shows the position (i.e., the number of bytes) in the lists to be referenced in a control operation. The number of root object lists field shows the number of root object lists. The root object list ID field shows an ID for identifying the uppermost root object list in the independent layers in the hierarchy.

The subunit dependent length field indicates the number of bytes in the subsequent subunit dependent information field. The subunit dependent information field shows information specific to the functions. The manufacturer dependent length field shows the number of bytes in the subsequent manufacturer dependent information field. The manufacturer dependent information field shows specification information determined by the vendor (i.e., manufacturer). When the descriptor has no manufacturer dependent information, the manufacturer dependent information field does not exist.

FIG. 15 is a diagram showing the list ID assignment ranges shown in FIG. 13. As shown in FIG. 15, the values at “0000h to 0FFFh” and “4000n to FFFFh” are reserved for future specification. The values at “1000h to 3FFFh” and “10000h to max list ID value” are prepared for identifying dependent information about function type.

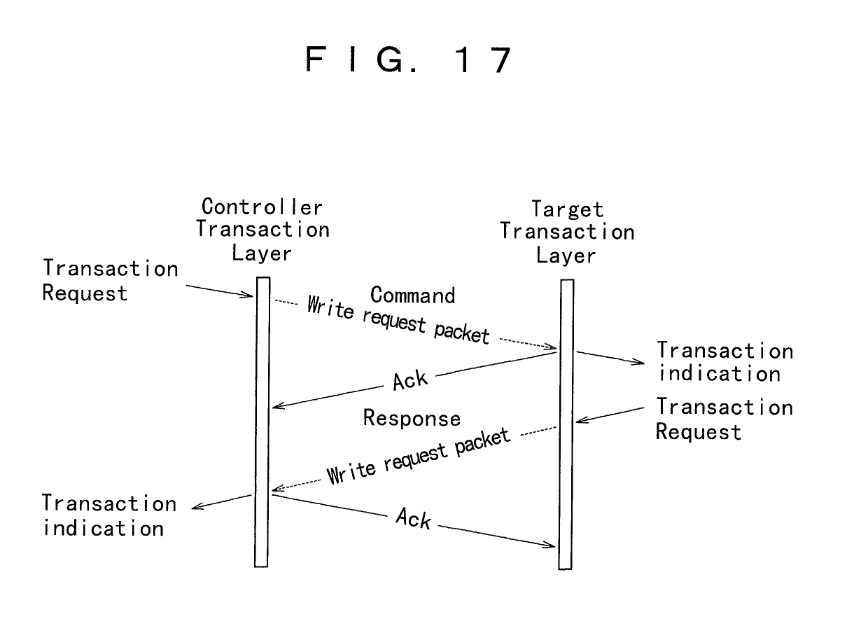

Next, the AV/C command set used in the system of this embodiment will be described with reference to FIGS. 16 to 21. FIG. 16 is a diagram showing a stack model of the AV/C command set. As shown in FIG. 16, a physical layer 81, a link layer 82, a transaction layer 83, and a serial bus management 84 conform to the IEEE 1394 standard. A functional control protocol (FCP) 85 conforms to the IEC 61883 standard. An AV/C command set 86 conforms to the 1394TA specification.

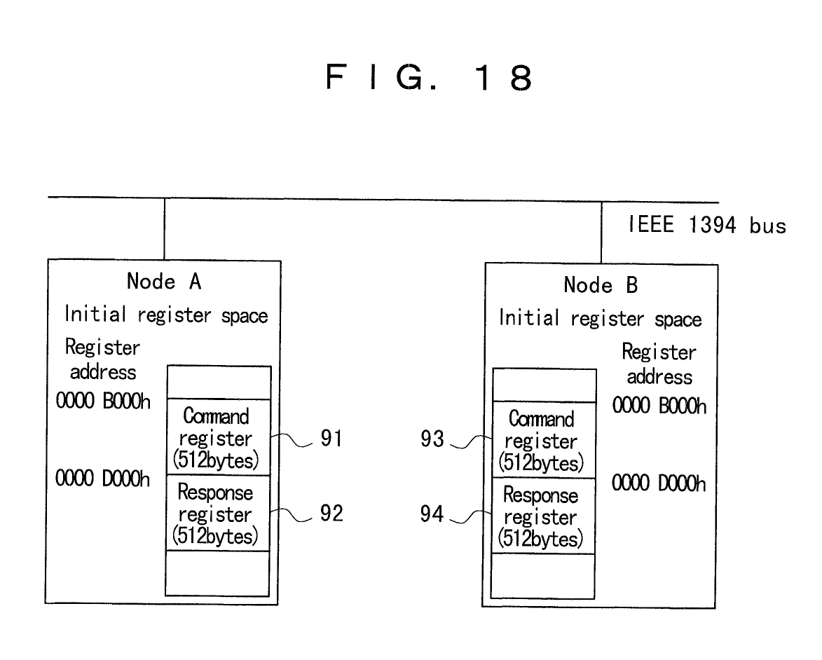

FIG. 17 is a diagram for illustrating a command and a response of the FCP 85 of FIG. 16. The FCP is a protocol for controlling the AV device in conformity with the IEEE 1394 standard. As shown in FIG. 17, a controller is a control side, and a target is a side to be controlled. In the FCP, the command is transmitted and received between nodes by use of the write transaction in the IEEE 1394 asynchronous transmission. Upon receiving data from the controller, the target returns an acknowledgement to the controller to confirm receipt.

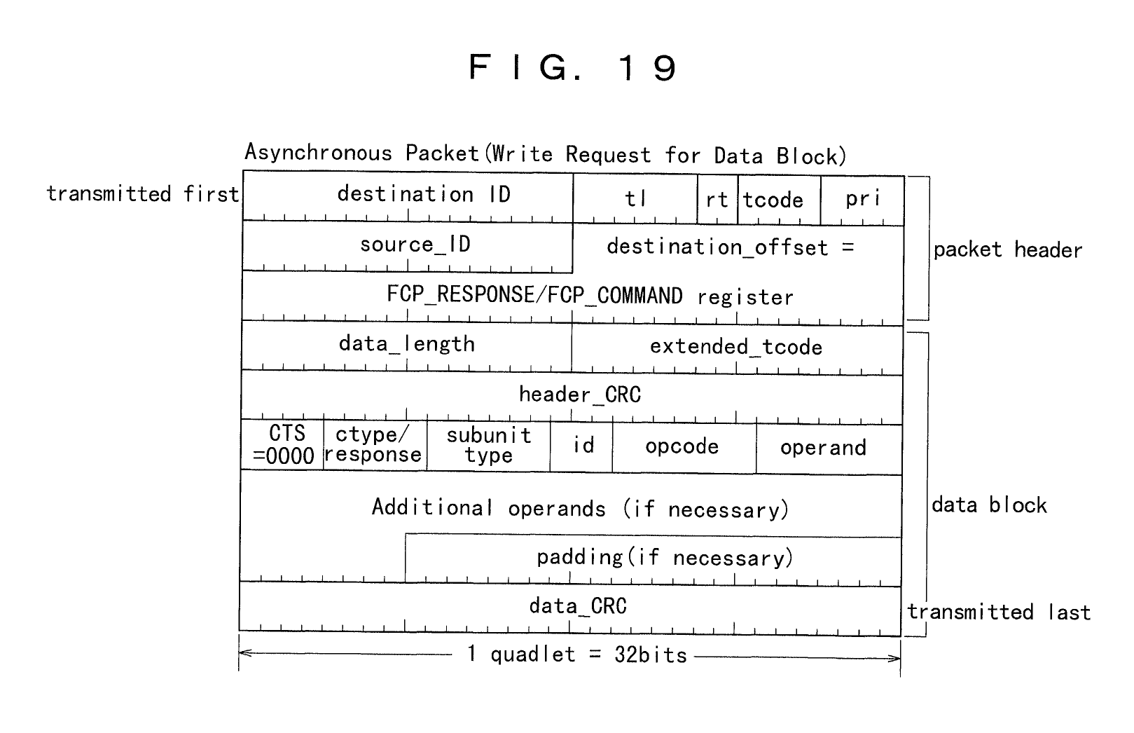

FIG. 18 is a diagram for further illustrating the relationship between a command and a response of the FCP shown in FIG. 17. A node A is connected with a node B via an IEEE 1394 bus. The node A is a controller, and the node B is a target. Both node A and node B have a command register and a response register, each with 512 bytes. As shown in FIG. 18, the controller writes a command message into the command register 93 in the target to convey a command thereto. Conversely, the target writes a response message into the response register 92 in the controller to convey a response thereto. Between these two messages, control information is exchanged. The type of the command set sent in the FCP is written in the CTS in the data field shown in FIG. 19, which will be described later.

FIG. 19 is a diagram showing a data structure of a packet of the AV/C command to be transmitted in the asynchronous transmission. The AV/C command set is a command set for controlling an AV device where the CTS (i.e., a command set ID)=“0000”. An AV/C command frame and a response frame are exchanged between nodes by use of the FCP described above. In order to prevent burdening the bus and the AV device, the time for responding to the command is limited to 100 ms. As shown in FIG. 19, the asynchronous packet data consists of 32 bits in a horizontal direction (i.e., quadlet). A header of the packet is shown in the upper half of FIG. 19, and a data block is shown in the lower half of FIG. 19. The destination_ID field shows an address.

The CTS field shows the command set ID, wherein CTS=“0000” for the AV/C command set. The ctype/response field shows the function classification of the command when the packet is a command, and shows the result of command processing when the packet is a response. Commands are roughly classified into four categories as follows: (1) a command for controlling a function from the outside (CONTROL); (2) a command for inquiring as to the state from the outside (STATUS); (3) a command for inquiring as to whether there is support for a control command from the outside (GENERAL INQUIRY for inquiring as to whether there is support for opcode, and SPECIFIC INQUIRY for inquiring as to whether there is support for opcode and operands); and (4) a command for requesting notification to the outside as to a change in state (NOTIFY).

What response is returned depends on the kind of the command. Responses to the control command are NOT IMPLEMENTED, ACCEPTED, REJECTED, and INTERIM. Responses to the STATUS command are NOT IMPLEMENTED, REJECTED, IN TRANSITION, and STABLE. Responses to the GENERAL INQUIRY command and the SPECIFIC INQUIRY command are IMPLEMENTED and NOT IMPLEMENTED. Responses to the NOTIFY command are NOT IMPLEMENTED, REJECTED, INTERIM, and CHANGED.

The subunit type field specifies the function of the device, and is assigned to identify a tape recorder/player, a tuner, and the like. In order to identify each subunit from others in the case where a plurality of subunits of the same kind exist, the subunit type executes addressing by use of a subunit ID as an identification number. The opcode field shows a command, and the operand field shows a parameter of the command. The additional operands fields are added if necessary. The padding field also is added if necessary. The data cyclic redundancy check (CRC) field is used for error check in data transmission.

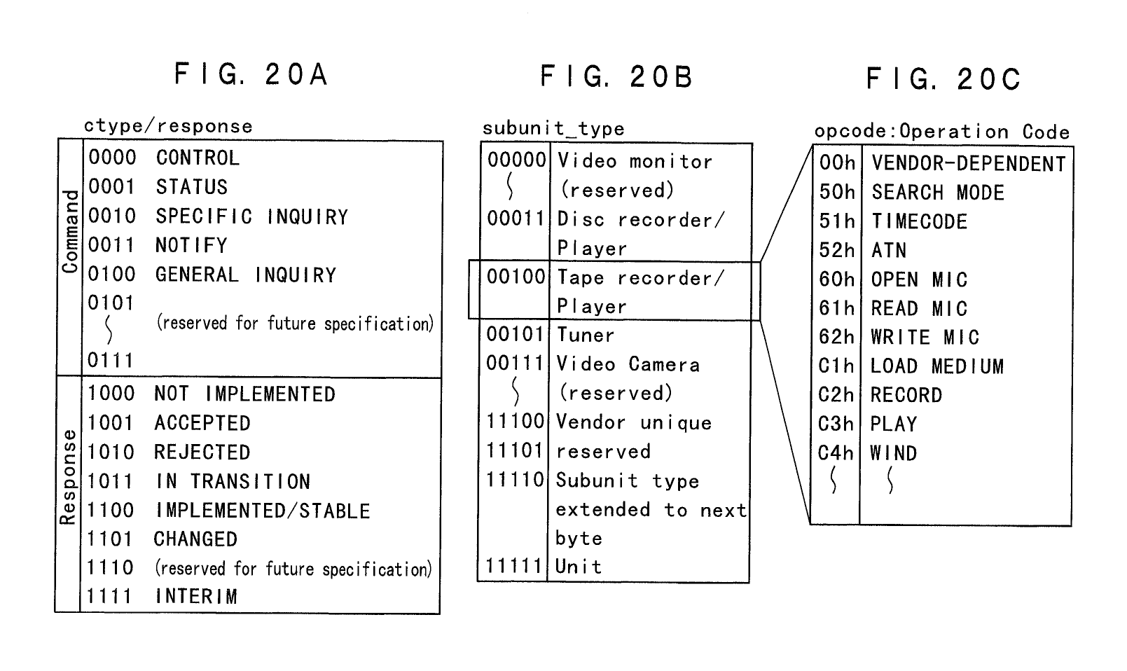

FIGS. 20A to 20C are diagrams showing specific examples of AV/C commands. FIG. 20A shows a specific example of the ctype/response field. The upper half of FIG. 20A shows commands, while the lower half of FIG. 20B shows responses. The value at “0000” is assigned with the CONTROL command, the value at “0001” is assigned with the STATUS command, the value at “0010” is assigned with the SPECIFIC INQUIRY command, the value at “0011” is assigned with the NOTIFY command, and the value at “0100” is assigned with the GENERAL INQUIRY command. The values at “0101” to “0111” are reserved for future specification. In addition, the value at “1000” is assigned with the NOT IMPLEMENTED response, the value at “1001” is assigned with the ACCEPTED response, the value at “1010” is assigned with the REJECTED response, the value at “1011” is assigned with the IN TRANSITION response, the value at “1100” is assigned with the IMPLEMENTED/STABLE response, the value at “1101” is assigned with the CHANGED response, and the value at “1111” is assigned with the INTERIM response. The value at “1110” is reserved for future specification.

FIG. 20B shows a specific example of the subunit type field. The value at “00000” is assigned with a video monitor, the value at “00011” is assigned with a disc recorder/player, the value at “00100” is assigned with a tape recorder/player, the value at “00101” is assigned with a tuner, the value at “00111” is assigned with a video camera, the value at “11100” is assigned with a vendor unique device, the value at “11110” is assigned to indicate that the subunit type is extended to the next byte. The value at “11111” is assigned with a unit, and is used for transmitting data to the device itself, for example, for turning on and off the electric power to the device.

FIG. 20C shows a specific example of the opcode field. Each subunit type has its own opcode table, and FIG. 20C shows the opcode table in the case where the subunit type is a tape recorder/player. In addition, an operand is defined for each opcode. In the example of FIG. 20C, the value at “00h” is assigned with VENDOR-DEPENDENT, the value at “50h” is assigned with SEARCH MODE, the value at “51h” is assigned with TIMECODE, the value at “52h” is assigned with ATN, the value at “60h” is assigned with OPEN MIC, the value at “61h” is assigned with READ MIC, the value at “62h” is assigned with WRITE MIC, the value at “C1h” is assigned with LOAD MEDIUM, the value at “C2h” is assigned with RECORD, the value at “C3h” is assigned with PLAY, and the value at “C4h” is assigned with WIND.

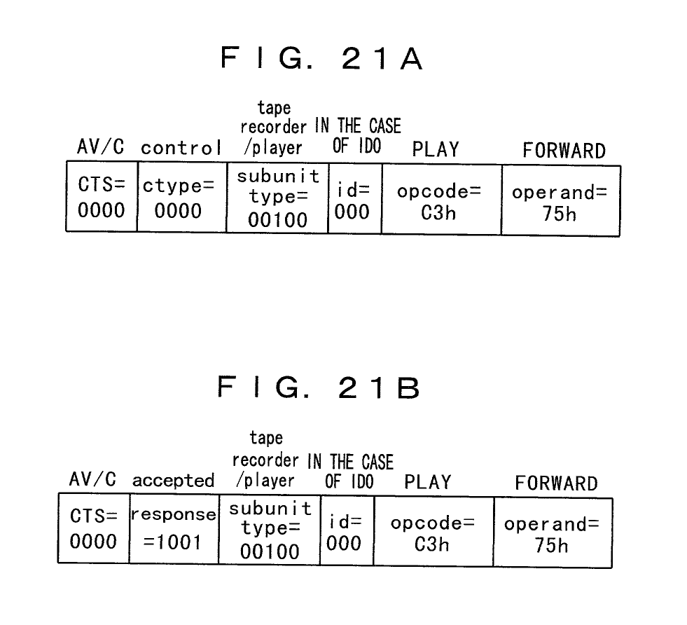

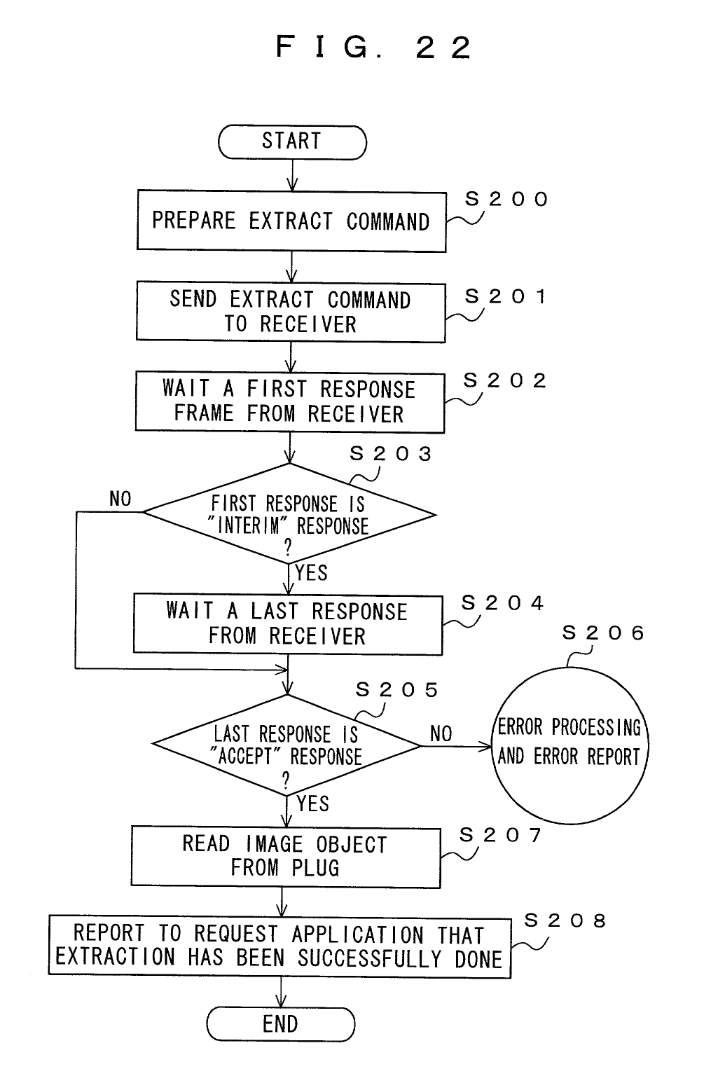

FIGS. 21A and 21B show specific examples of the AV/C command and response. For example, when an instruction for executing reproduction is provided to a reproducing device as a target (consumer), the controller sends a command such as shown in FIG. 21A to the target. Since this command uses the AV/C command set, the CTS is at the value at “0000”. Since the command for controlling the device from the outside (CONTROL) is used for the ctype, the ctype is at the value at “0000” (see FIG. 20A). Since the subunit type is a tape recorder/player, the subunit type is at the value at “00100” (see FIG. 20B). The id shows the case of ID0, wherein the id is at the value of “000”. The opcode is at the value of “C3h” which means PLAY (reproduce) (see FIG. 20C). The operand is at the value of “75h” which means FORWARD. When reproduced, the target returns a response to the controller, such as shown in FIG. 21B. In the example shown in FIG. 21B, “accepted”, meaning that the data has been received, is part of the response and, therefore, the response is at the value of “1001” (see FIG. 20A). Except for the response, the other configurations of FIG. 21B are basically the same as of FIG. 21A and, therefore, their descriptions will be omitted.

The AV/C command described above (i.e., “AV/C Digital Interface Command Set, General Specification, version 3.0, Apr. 15, 1998”) provides an object number select (ONS) command for performing any one of various operations (i.e., subfunctions) on one or plural objects in the device. Table 1 lists the currently defined subfunctions.

TABLE 1
ONS subfunctions

| Sub | | |
|---|---|---|
| function | Value | Action |
| clear | CO₁₆ | Stop the output of all selections on the specified |
| | | plug. No selection specifiers shall he included in |
| | | the command frame for this subfunction. |
| remove | DO₁₆ | Remove the specified selection from the output stream |
| | | on the specified plug. |
| append | D1₁₆ | Add (multiplex) the specified selection to the |
| | | current output. |
| replace | D2₁₆ | Remove the current selection from the specified plug, |
| | | and output or multiplex the specified selection. |
| new | D3₁₆ | Output the specified selection on the specified plug |
| | | if the plug is currently unused: otherwise, REJECT |
| | | the selection command. |
| X | All | Reserved for future specification |
| | others | |

In the present invention, a new object number select subfunction, that is, extract, is prepared. The extract subfunction is used for extracting the video frame from the video track on a disc medium, converting the video frame into a still image format, and then outputting an object to a specified plug. The extract subfunction resembles a new subfunction in that it always outputs a selected matter specified in a specified plug in the case where no plug is used. In the case where a plug is in use, the disc subunit 200 immediately returns a reject answer code.

As in the case of other ONS subfunctions, the extract subfunction can send a plurality of extract commands in one request, by allowing two or more selection specifications (ons_selection_specifications) to be included in one request (see section 10.5 of the “AV/C Digital Interface Command Set, General Specification” described above). The ability to request a plurality of images by one command is important to reduce the amount of data (i.e., traffic) exchanged on the IEEE 1394 bus, and is especially important in the video browsing application where a plurality of images are immediately processed and transmitted.

The application which is making a request needs to specify, in addition to the format of the image to be returned, a frame to be extracted if it is known, and the size of the requested image if necessary. Other details of the ONS function, such as the specification of the object (AV track), are described in section 10.5 of the “AV/C Digital Interface Command Set, General Specification” described above, and are well known by those skilled in the art.

Hereinafter, the “specification of the position in the video stream” will be described.

The position in the video stream is indicated by use of a position indicator block, as is described in section 6.3 of the “Enhancements to the AV/C General Specification 3.0, Version 1.0, Jan. 26, 1999”. An accurate method for specifying position information depends on an example of a specific subunit.

The “AV/C Disc Subunit Enhancements for Hard Disc Drive Specification” described above defines the AV frame as a section which can be individually identified in the AV track. The strict meaning thereof is defined by a disc unit, and normally depends on the encoding format which a disc unit supports. There is no need for the disc unit to support the operation which uses the AV frame.

The present invention is applied to the IEEE-1394 disc unit for supporting the positioning conducted by the AV frame. Section 5.2 of the “Enhancements to the AV/C General Specification” described above defines the structure of a position marker info block having three different position marker types, that is, relative HMSF (relative_HMSF), relative segment count (relative_segment_count), and relative byte count (relative_byte_count).

Table 2 shows the position indicator info block defined in section 5.2 of the “Enhancements to the AV/C General Specification” described above. The field of the indicator type (indicator_type) is one of the position marker types listed in Table 3.

TABLE 2
Position indicator info block
position_indicator_info_block

| Offset | Contents |
|---|---|
| 00 00₁₆ | compound_length |
| 00 01₁₆ | |
| 00 02₁₆ | info_block_type = 00 02₁₆ |
| 00 03₁₆ | (position_indicator_info_block |
| 00 04₁₆ | primary_fields_length |
| 00 05₁₆ | |
| 00 06₁₆ | indicator_type |
| 00 07₁₆ | indicator_type_specific |
| . | |
| . | |
| . | |

TABLE 3
Position marker type
Position Marker Types

| Value | Meaning |
|---|---|
| 00 00₁₆ | relative_HMSF_count |
| 00 01₁₆ | relative_segment_count |
| 00 02₁₆ | reserved |
| 00 03₁₆ | reserved |
| 00 04₁₆ | reserved |
| 00 05₁₆ | reserved |
| 00 06₁₆ | reserved |
| 00 07₁₆ | reserved |
| all other | reserved |
| values | |

The meanings of the different position marker types and information specific to the indicator types thereof are the same as those described in section 6.3 of the “Enhancements to the AV/C General Specification 3.0” described above. The relative HMSF count (relative_HMSF_count) allows specification of one AV frame through the use of hours, minutes, seconds, and the number of frames counted from the initiation of the AV track. The relative segment count (relative_segment_count) is defined only in the case where the tracks are divided into segments (that is, in the case defined in the section 2.1 of the “Enhancements to the AV/C General Specification” described above).

When a segment is specified, the disc subunit is permitted to return any one of the frames in the segment. In this case, the most typical frame is returned from the segment, for example. The typical frame may be selected by manual operation, or alternatively, may be automatically selected by any one of plural algorithms which are well known by those skilled in the art. Such information can be stored in the info block (info_block) which conforms to the IEEE 1394 standard, or can be stored by employing any unique method.

Contrary to the above, if a position marker type of the relative segment count is specified, the first frame of the video segment can be returned.

Next, “specification of image size and format” will be described.

The “AV/C Disc Subunit General Specification 1.0” described above specifies a place holder for entry type of an object of a “digital still image” disc subunit. However, no still image format is specified in the “AV/C Disc Subunit General Specification 1.0”. Therefore, there is a need for a method for providing an image format and an image format version. For this reason, in order to specify both the image format and the requested size, the image size/format block such as shown in Table 4 is introduced.

TABLE 4
Image size/format block
image_size_and_format_block

| Address | |
|---|---|
| Offset | Contents |
| 00 00₁₆ | image_size_type |
| 00 01₁₆ | image_width |
| 00 02₁₆ | |
| 00 03₁₆ | image_height |
| 00 04₁₆ | |
| 00 05₁₆ | image_format_info_block |

Each of the fields of the image size/format block has the meanings described below.

Image size (image_size_type): One of the image size types shown in Table 5 below.

TABLE 5
Image size type
image_size_type

| Value | Meaning |
|---|---|
| 00₁₆ | user_specified_image_size |
| 01₁₆ | native_image_size |
| 02₁₆ | native_thumbnail_image_size |

Image width (image_width): the number of pixels corresponding to the width of the requested image. If no width is specified, the value of 0 is set.

Image height (image_height): the number of pixels corresponding to the height of the requested image. If no height is specified, the value of 0 is set.

Image format info block (image_format_info_block): this is defined in section 6.12 of the “Enhancements to the AV/C General Specification 3.0” described above. Section 6.12 defines only one image format (mini-disc and audio MD1 image format) for use in a general AV/C. That is, the Exif 2.1 standard is added to the list of section 6.12. Exif 2.1 is a format in which important metadata such as time, data, settings of camera, and the like are added to the JPEG image data.

The disc subunit may be designed in such a manner that it neglects the image size hint. For example, the disc subunit may be designed in such a manner that it always returns a native image size. The actual image size of the returned image can be known from the application, by checking the information which is dependent on the image format.

The image size type has the meaning as follows.

User specified image size (user_specified_image size): The width and height are specified by the image size and format block (image_size_and_format_block). The value specified by the user is used as a hint. The subunit may return an image in a different size from that specified by the user. Either one of the image width or the image height of the requested image may be set to “0” (not both of them) When either one of the image width or the image height is set to “0”, the subunit may calculate the value of dimension other than “0” so as to maintain the aspect ratio of the original image as far as possible.

Native image size (native_image_size): The subunit returns the image by use of the native size thereof. When plural native sizes are supported, the subunit may select any one from the native sizes.

Native thumbnail image size (native_thumbnail_image_size): The subunit may return the image of a miniature version in a size convenient for the subunit. Some of the images may have thumbnail images which are calculated beforehand in such a manner that they can be returned with no need for any image processing. Other formats may have abilities to produce images of specific miniature sizes at very high speed. For example, the format of DCT base can produce an image of miniature size by use of DC value of each DCT block, without performing reverse DCT calculation.

Next, a modification of “an object number select (ONS) specification” will be described.

In this description, it is suggested that the ONS selection specification structure of the disc subunit (see section 10.16.1 of the “AV/C Disc Subunit, General Specification 1.0” described above) is modified in such a manner as to include the AV stream position, image size, and image format.

Each of Tables 6 and 7 shows the target field in the ONS selection specification structure of the disc subunit which is modified in such a manner as to include the stream position, image size, and image format.

TABLE 6
Target field in the modified ONS
selection specification structure
target field (“don't care” specification)

| Address | Contents | | | |
|---|---|---|---|---|
| offset | | | | |
| 00 00₁₆ | list_ID | | | |
| : | | | {close oversize brace} | F-01 |
| : | object_position | | | |
| : | | | | |
| : | number_of_children = FF₁₆ | | | |
| : | position_indicator_info_block | | | |
| | | | {close oversize brace} | F-02 |
| : | | | | |
| : | image_size_and_format | image_size_type | | |
| : | | image_width | | |
| : | | | | |
| : | | image_height | {close oversize brace} | F-03 |
| : | | | | |
| : | | image_format_info_block | | |

TABLE 2
Target field in the modified ONS selection
specification structure
target field (“don't care” specification)

| Address | Contents | | | |
|---|---|---|---|---|
| offset | | | | |
| 00 00₁₆ | list_Type | | | |
| : | | | {close oversize brace} | F-04 |
| : | (Object ID) | | | |
| : | | | | |
| : | number_of_children = FF₁₆ | | | |
| : | position_indicator_info_block | | | |
| | | | {close oversize brace} | F-05 |
| : | | | | |
| : | image_size_and_format | image_size_type | | |
| : | | image_width | | |
| : | | | | |
| : | | image_height | {close oversize brace} | F-06 |
| : | | | | |
| : | | image_format_info_block | | |

Table 6 shows the case where the specifier type flag is 0, and an object is referred to by its list ID and the object position. Table 7 shows the case where the specifier type flag is 1, and an object is referred to by its list type and the object ID. In both cases shown in Tables 6 and 7, when the field of the number of children (number_of_children) is set to 0×FF₁₆, the target field is defined as including position indicator info block (position_indicator_info_block), and image size and format block (image_size_and_format).

When the field of the number of children is set to 0×00₁₆, as described in section 10.16.1 of the “AV/C Disc Subunit, General Specification 1.0” described above, the target field includes neither position indicator info block nor image size and format block. When the ONS command is sent to the disc subunit together with the extract subaction, the field of the number of children is required to be set to 0×FF₁₆.

The fields F-01 and F-04 are fields which have been conventionally defied as to the disc subunits, and are described in section 10.16.1 of the “AV/C Disc Subunit, General Specification 1.0” described above. The fields F-02 and F-05 are position indicator info blocks which have been already described above, and also described in section 6.3 of the “Enhancements to the AV/C General Specification 3.0”. The fields F-03 and F-06 are image size and format blocks which have been already described above, and are shown in Table 4.

Next, “a flow of extract command” will be described.

The operation of the sender 11 which sends an extract command will be described, referring to FIG. 22.

First, in Step S200, the sender 11 prepares an extract command (ONS extract AV/C command). In this case, the sender 11 specifies plural AV streams (target objects), a position of the frame to be extracted, an image size and output image format, and an output plug.

Next, in Step S201, the sender 11 sends the extract command to the receiver 12 by use of the 1394 AV/C protocol.

Then, in Step S202, the sender 11 waits for a first response frame to be sent from the receiver 12. In this case, if the 1394 bus is reset during the period when the sender 11 is in this waiting state, for example, the sender 11 may abandon the request by the extract command described above. In addition, if the period during which the sender 11 waits to receive the first response exceeds 100 ms, the sender 11 may abandon the request by the extract command described above, or may again send the extract command.

Then, in Step S203, the sender 11 judges whether or not the first response is the INTERIM response. When the first response is the INTERIM response, the sender 11 proceeds to Step S204 where the sender 11 waits for a last response frame to be sent from the receiver 12. Conversely, when the first response is not the INTERIM response, the sender 11 treats the first response as a last response.

Then, in Step S205, the sender 11 judges whether or not the last response is the ACCEPT response. When the last response is not the ACCEPT response (NOT IMPLEMENTED response, REJECTED response, and the like), this means that the request by the extract command has failed. In this case, the sender 11 performs error processing and error reporting in Step S206. Conversely, when the last response is the ACCEPT response, the sender 11 proceeds to Step S207 where the image object is read from the requested plug. After that, in Step S208, the sender 11 reports to the requested application that the extraction has been successfully done.

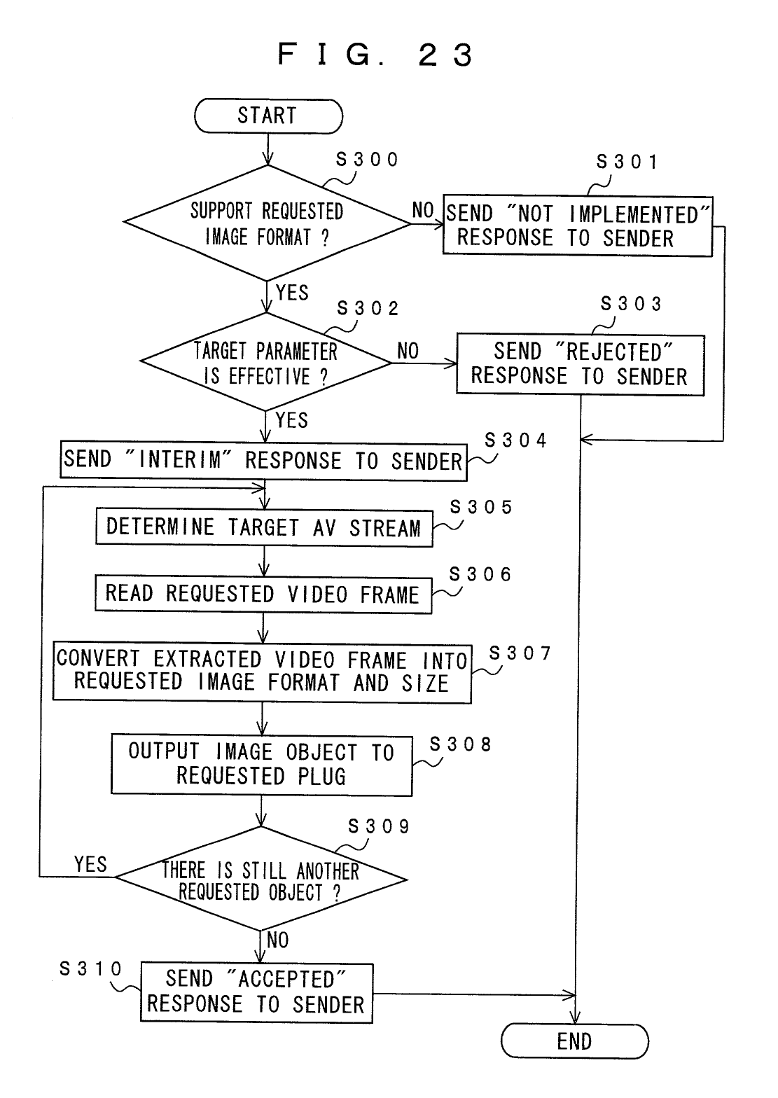

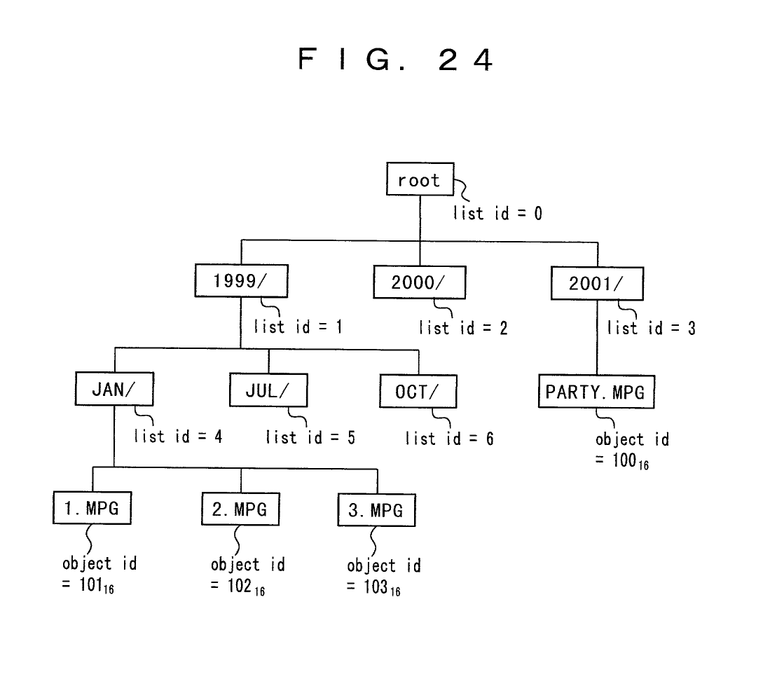

Hereinafter, an operation of the receiver 12 (the disc subunit 200) which receives the extract command will be described, referring to FIG. 23.

First, in Step S300, the receiver 12 judges whether or not the image format requested by the extract command is supported. When the requested image format is not supported, the receiver 12 proceeds to Step S301 where the receiver 12 sends a NOT IMPLEMENTED response to the sender 11. Then, the process is finished. In contrast, when the requested image format is supported, the receiver 12 proceeds to Step S302 where the receiver 12 checks the validity of the remaining target parameters.

The details of the checking operation depend on the hardware. The checking operation should be completed within looms. For example, the subunit waits for the requested AV object, and checks whether or not positioning to the requested position is possible.

When the target parameter is not valid, the receiver 12 sends a REJECTED response to the sender 11 in Step S303, and the process is finished. Conversely, when the target parameter is valid, or the receiver 12 needs the time of 100 ms or longer to further verify the parameter, the receiver 12 sends an INTERIM response to the sender 11 in Step S304.

In Step S305, the receiver 12 determines the target AV stream, and makes preparations for reading the video frame of the requested position in a device-dependent or video format-dependent method. Then, the receiver 12 reads the requested video frame in Step S306. In this case, when extracting the video frame, the subunit may employ any method suitable to the subunit, whatever method it is. For example, in the case where an MPEG 2 stream is used as the AV stream, the entire group of pictures (GOP) is read, and is decoded by a decoder in hardware. In this manner, the requested and correct video frame is extracted.

Then, in Step S307, the receiver 12 converts the extracted video frame into the requested image format (still image format) by use of the image processor 203. In this case, the image is scaled up or down in accordance with the size parameter requested by the sender 11.

Then, in Step S308, the receiver 12 outputs the image object to the requested plug, as is described in section 10.16 of the “AV/C Disc Subunit General Specification 1.0” described above.

Then, in Step S309, the receiver 12 judges whether or not there is another required object. When there is another object, the receiver 12 returns to Step S305. In other words, when plural objects are required, the receiver 12 repeats the process of Steps S305 to S309 until it processes all the objects.

When the process for all the requested objects are finished, the receiver 12 sends an ACCEPT response to the sender 11 in Step S310. Then, the process is finished.

Hereinafter, “sample extraction request” will be described.

FIG. 24 is a diagram showing an exemplary directory structure of a disc. In FIG. 24, a list is shown by a name which ends in slash (/), and an object is shown as a video file having a name which ends in “.MPG”. Each list is related to the specific list ID between its peer objects. Similarly, each object is assigned with a specific object ID within the list including the object.

In this embodiment, in order to extract the first frame from two objects, the messages “/1999/JAN/2.MPG” and “/2001/PARTY.MPG” are sent. For this purpose, as shown in Table 8 below, an ONS extract AV/C command having two ONS selection specification (ons_selection_specification) operands is prepared.

TABLE 8
Example of ONS extract AV/C command

| | Description | Value |
|---|---|---|
| opcode | OBJECT NUMBER SELECT | 0D₁₆ |
| operand[0] | source_plug | 00₁₆ |
| operand[1] | subfunction = extract | D4₁₆ |
| operand[2] | status | 00₁₆ |
| operand[3] | numer_of_ons_selection_specifications | 02₁₆ |
| operand[4] | ons_selection_specification[0] | : |
| : | | : |
| operand[5] | ons_selection_specification[1] | : |
| : | | : |

When specifying the object, the request side has the option of using the list ID and the object position, or to use the list type and the object ID (the reference of the target object). Hereinafter, an example of each of these options will be described.

Table 9 shows a first ONS selection specification for specifying “/1999/JAN/2.MPG” (object ID=102₁₆).

TABLE 9
ONS selection specification

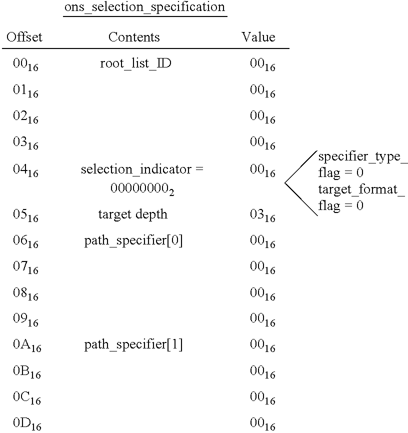

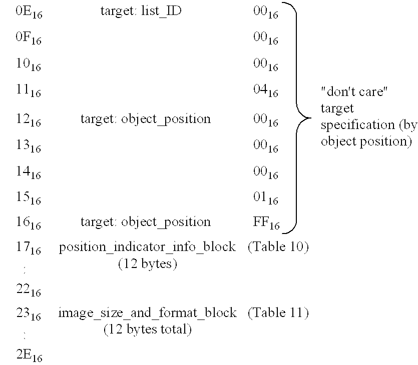

The field of the selection indicator (selection_indicator) includes two important flags which show the formats of the target references. The most significant bit is a specifier type flag. The specifier type flag of 1 means that the path and the object are specified by the object ID. The specifier type flag of 0 means that the path and the object are specified by the positions in the parent list. In this embodiment, the specifier type flag is set to 0, and the path and the object are specified by the list ID and the object position.

The least significant bit is a target format flag. The disc subunit is required to set the flag to 0, in order to show that all the objects are specified, instead of specifying only a specific child of a certain object.

The depth of the target for reaching “/1999/JAN/2.MPG” is 3 counted from the route. In this case, the path specifier entry (path_specifier_entry) is an object position, and the first object has a position of “0”. It can be understood from FIG. 24 that, in order to reach “/1999/JAN/2.MPG”, the object position of 0 as to “1999”, the object position of 0 as to “JAN”, and the object position of 1 as to “2.MPG” have to be passed. In this embodiment, it is assumed that the specific disc subunit uses 4 bytes for the list ID and the object position.

In Table 9 above, the target fields show the list ID, the object position (object_position) of the target “2.MPG”, and the number of children (number_of_children).

In the structure of the ONS selection specification including the position indicator information, and the image size and format information, as has been described above, the value of FF₁₆ is set to the field of the number of children (number_of_children). Specifically, when the field of the number of children has the value equal to FF₁₆, as is shown in the lower portion in Table 9, the field of the number of children (number_of_children) is followed by the position indicator info block (position_indicator_info_block), and the image size and format block information (image_size_and_format).

Table 10 shows the position specification block showing the first frame (0) of the AV track. The position specification block uses the absolute HMSF count indicator type which is described in section 6.3 of the “Enhancements to the AV/C General Specification 3.0” described above.

TABLE 10
Position specification block showing first frame of AV track
position_indicator_info_block

| Offset | Contents | Value |
|---|---|---|
| 00₁₆ | | 00₁₆ |
| 01₁₆ | compound_length | 0A₁₆ |
| 02₁₆ | | 00₁₆ |
| 03₁₆ | info block type = | |
| | position_indicator_info_block | 02₁₆ |
| 04₁₆ | | 00₁₆ |
| 05₁₆ | primary_fields_length | 06₁₆ |
| 06₁₆ | indicator_type = Absolute HMSF Count | 02₁₆ |
| 07₁₆ | hours (MSB) | 00₁₆ |
| 08₁₆ | hours (LSB) | 00₁₆ |
| 09₁₆ | minutes | 00₁₆ |
| 0A₁₆ | seconds | 00₁₆ |
| 0B₁₆ | frame | 00₁₆ |

Table 11 shows an exemplary image size and format block.

TABLE 11
Image size and format block

| | image_size and_format_block | |
|---|---|---|
| Offset | Contents | Value |
| 00₁₆ | image_size_type = user_specified_image_size | 00₁₆ |
| 01₁₆ | image_width = 32 | 00₁₆ |
| 02₁₆ | | 20₁₆ |
| 03₁₆ | image_height = 0 (subunit computed) | 00₁₆ |
| 04₁₆ | | 00₁₆ |
| 05₁₆ | image_format_info_block | (Table 12) |
| 0B₁₆ | (7 bytes) | |

In this embodiment, the image size type (image_size_type) is set to the user specified image size (user_specified_image_size). In this embodiment, thumbnail images with the image size (image_size) 32 are requested. The image height (image_height) is set to 0. This means that an appropriate height should be calculated in such a manner that the subunit maintains the aspect ratio of the original image as accurately as possible.

The image format info block (image_format_info_block) is a standard info block which is described in section 6.12 of the “Enhancements to the AV/C General Specification 3.0” described above. Table 12 shows an exemplary image format info block. In this embodiment, a newly added Exif 2.1 (90₁₆) is specified as the image format (image_format) as has been described above.

TABLE 12
Image format info block

| | image_format_info_block | |
|---|---|---|
| Offset | Contents | Value |
| 00₁₆ | | 00₁₆ |
| 01₁₆ | compound_length | 05₁₆ |
| 02₁₆ | info_block_type = image_format_info_block | 00₁₆ |
| 03₁₆ | | 0E₁₆ |
| 04₁₆ | primary_fields_length | 00₁₆ |
| 05₁₆ | | 01₁₆ |
| 06₁₆ | image_format = Exif2.1 | 90₁₆ |

In the image format info block shown in Table 12, no field of the image format specification (image_format_specific) is used. Alternative to this, a field of the image format specification may be added.

Table 13 shows a second ONS selection specification for specifying “/2001/PARTY.MPG” (object ID=100₁₆).

TABLE 13
ONS selection specification

| | ons_selection_specification | | |
|---|---|---|---|
| Offset | Contents | Value | |
| 00₁₆ | root_list_ID | 00₁₆ | |
| 01₁₆ | | 00₁₆ | |
| 02₁₆ | | 00₁₆ | |
| 03₁₆ | | 00₁₆ | |
| 04₁₆ | selection_indicator = | 80₁₆ | specifier |
| | 10000000₂ | | type_flag = 1 |
| | | | target_format |
| | | | _flag = 0 |
| 05₁₆ | target_depth | 02₁₆ | |
| 06₁₆ | path_specifier [D] | 00₁₆ | |
| 07₁₆ | | 00₁₆ | |
| 08₁₆ | | 00₁₆ | |
| 09₁₆ | | 03₁₆ | |
| 0A₁₆ | target:target_object_reference | 00₁₆ | |
| 0B₁₆ | | 00₁₆ | |
| 0C₁₆ | | 10₁₆ | |
| 0D₁₆ | (object ID) | 00₁₆ | |
| 0E₁₆ | target:number_of_children | FF₁₆ | |
| 0F₁₆ | position_indicator_info_block | (Table | |
| . | (12 bytes) | 10) | |
| . | | | |
| . | | | |
| 1A₁₆ | | | |
| 1B₁₆ | image_size_and_format_block | (Table | |
| . | (12 bytes total) | 11) | |
| . | | | |
| . | | | |
| 26₁₆ | | | |

In this case, the specifier type flag is set to 1. As shown in Table 13, the references of path and object are performed by the object ID. In this embodiment, the same frame and image size as of the first ONS selection specification (see Table 9) are employed. Therefore, the position indicator info block (position_indicator_info block) and the image size and format block (image_size_and_format_block) have the same structures as of the first ONS selection specification.

In the embodiment described above, the present invention has been applied to an electronic device connected to the IEEE 1394 network. It would be obvious that the present invention is also applicable to other electronic devices connected to other kinds of networks.

According to the present invention, an information processor is structured in a manner that it sends to another information processor connected to a network a command for requesting the extraction and generation of a specified video frame of a video stream recorded in a record medium, and for requesting that the video frame be sent after converting it into still image data, and that the information processor receives still image data of the specified video frame from another information processor. With this arrangement, the specified video frame can be extracted as a still image from the video stream recorded in the record medium of another information processor.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A first information processor connected to a network with another information processor having a record medium recorded with a video stream, the first information processor comprising:
a command generator operable to generate a command requesting the another information processor to extract and produce a specified video frame of the video stream recorded in the record medium, and to send the video frame after converting it into still image data;
a command sender operable to send the command to the another information processor; and
an image data receiver operable to receive the still image data from the another information processor.

2. A first information processor according to claim 1, further comprising a video frame specifier operable to specify the specified video frame, wherein the command includes information about the specified frame.

3. A first information processor according to claim 2, wherein the video frame specifier specifies one or plural video frames.

4. A first information processor according to claim 1, further comprising an image format specifier operable to specify an image format of the still image data, wherein the command includes information about the image format.

5. A first information processor according to claim 1, further comprising an image size specifier operable to specify a size of the still image, wherein the command includes information about the size of the still image.

6. A first information processor according to claim 1, wherein the network is an IEEE 1394 serial bus.

7. A first information processor according to claim 6, further comprising output plug specification information operable to specify an output plug for outputting the still image data from the another information processor, wherein the command includes information about the output plug.

8. A method for processing information in a first information processor connected to a network with another information processor having a record medium recorded with a video stream, the method comprising:
generating in the first information processor a command requesting the another information processor to extract and produce a specified video frame of the video stream recorded in the record medium, and to send the video frame after converting it into still image data;
sending the generated command to the another information processor; and
receiving in the first information processor the still image data sent from the another information processor.

9. A first information processor connected to a network with another information processor, the first information processor comprising:
a record medium in which a video stream is recorded;
a command receiver operable to receive a command from the another information processor requesting that a specified video frame of the video stream recorded in the record medium be extracted and generated and that the specified video frame be sent after converting it into still image data;
a video frame extractor and generator operable to extract and generate the specified video frame from the record medium based on the command received by the command receiver;
an image data converter operable to obtain still image data from the specified video frame extracted and generated by the video frame extractor and generator; and
an image data sender operable to send the still image data to the another information processor.

10. A first information processor according to claim 9, wherein the command received by the command receiver includes video frame specification information operable to specify the video frame to be extracted and generated,
wherein the video frame extractor and generator extracts and generates the video frame specified by the video frame specification information.

11. A first information processor according to claim 9, wherein the command received by the command receiver includes image format specification information operable to specify an image format of the still image data,
wherein the image data converter obtains the still image data in the image format specified by the image format specification information.

12. A first information processor according to claim 9, wherein the command received by the command receiver includes image size specification information for specifying a size of the still image data, and
wherein the image data converter obtains the still image data in the size specified by the image size specification information.

13. A first information processor according to claim 9, wherein the network is an IEEE 1394 serial bus.

14. A first information processor according to claim 13, wherein the command received by the command receiver includes output plug specification information operable to specify an output plug for outputting the still image data,
wherein the image data sender sends the still image data to the output plug specified by the output plug specification information.

15. A method for processing information in a first information processor connected to a network with another information processor, the first video processor having a record medium recorded with a video stream, the method comprising:
receiving in the first information processor a command from the another information processor requesting that a specified video frame of the video stream be extracted and generated, and that the specified video frame be sent after converting it into still image data;
extracting and generating the specified video frame from the record medium based on the received command;
obtaining still image data from the specified video frame which has been extracted and generated; and
sending the obtained still image data to the another information processor.
